(19) United States
(12) Patent Application Publication
(10) Pub. No.: US 2019/0051165 A1
(43) Pub. Date: Feb. 14, 2019

(54) METHOD FOR USE IN A VEHICLE

(71) Applicant: JAGUAR LAND ROVER LIMITED, Warwickshire (GB)

(72) Inventor: Felicity HARER, Whitley (GB)

(21) Appl. No.: 16/059,329

(22) Filed: Aug. 9, 2018

(30) Foreign Application Priority Data
Aug. 11, 2017 (GB) 1712898.4

(51) Int. Cl. G08G 1/017; G06K 9/00; G06T 7/00; G08G 1/04; G08G 1/00

(52) U.S. Cl. CPC G08G 1/0175; G06K 9/00791; G08G 1/20; G08G 1/04; G06T 7/0002

(57) ABSTRACT

A method for determining if a first vehicle is being followed by a second vehicle, the method comprising: capturing image data from the first vehicle, of one or more vehicles in the vicinity of the first vehicle, over a time period; analysing the captured image data to identify one or more vehicles; and determining that the second vehicle is following the first vehicle, in dependence on the second vehicle appearing more than once amongst the one or more identified vehicles.

### CROSS REFERENCE TO RELATED APPLICATION

This application claims priority to United Kingdom Patent Application No. GB 1712898.4, filed on 11 Aug. 2017.

### TECHNICAL FIELD

The present disclosure relates to a method for use in a vehicle and particularly, but not exclusively, to a method for determining if a first vehicle is being followed by a second vehicle. Aspects of the invention relate to a system, to a controller, to a vehicle and to a computer program product.

### BACKGROUND

In certain scenarios, it is important for a driver or other user of a vehicle to be aware of other vehicles which may be following them. For example, when traveling in a convoy it is often important for the leading vehicle to monitor whether the trailing vehicles are following. Similarly, for security purposes in particular when transporting valuable cargo and/or passengers it may be necessary to determine if a vehicle is being followed.

Currently, determining if a vehicle is being followed is reliant on human observation and skill. Similarly, a skilled pursuer is trained to vary the distance at which they may be following a vehicle so that they appear and disappear from the leading vehicle's field of view. Accordingly, it can be very difficult to determine if a vehicle is being followed. Typically, such monitoring of following vehicles is performed by the driver of the vehicle and will often require a large amount of training to be performed correctly and is obviously susceptible to human error.

The present invention has been devised to mitigate or overcome at least some of the above-mentioned problems.

### SUMMARY OF THE INVENTION

According to an aspect of the present invention, there is provided a method of determining if a first vehicle is being followed by a second vehicle, the method comprising capturing image data from the first vehicle of one or more vehicles in the vicinity of the first vehicle over a time period, analysing the captured image data to identify one or more vehicles, and determining that the second vehicle is following the first vehicle, in dependence on the second vehicle appearing more than once amongst the one or more identified vehicles.

The method described in the present invention uses information provided by a vehicle to monitor the vehicle's external environment, thereby removing any need for a human observer and also removing any associated element of human error.

In certain embodiments an occupant of the first vehicle may be alerted when the second vehicle is determined to be following the first vehicle. The alert may be a visual alert and/or an audio alert.

The method may comprise analysing one or more characteristics of the captured image data.

In certain embodiments the captured image data may comprise a plurality of image frames, and the analysing comprises identifying one or more vehicles within the plurality of image frames, and the determining comprises establishing if the same vehicle appears in two or more of the image frames, captured over the time period.

Optionally, determining if the second vehicle is following the first vehicle comprises determining if a relevant predefined threshold condition is satisfied. The predefined threshold condition may be dependent on an environment in which the first vehicle is traveling. In certain embodiments the environment may be dependent on one or more of: traffic levels, road types, road conditions, average road speed, location of the road, and the classification of the road. Such a dependency provides the advantage of reducing the likelihood of false warnings that the first vehicle is being followed by increasing the threshold condition for assessing whether the first vehicle is being followed. In some circumstances, a second vehicle in the external surroundings of the first vehicle may appear in a plurality of captured image frames despite not actively following the first vehicle. For example, if the first vehicle is in an environment where the vehicle's external surroundings are expected to remain unchanged for a long period of time, it may be desirable to require that a second vehicle appear in a greater number of image frames before it is identified as following the first vehicle than in an environment where the first vehicle's external surroundings are expected to vary frequently.

In certain embodiments the predefined threshold condition may be dependent on a situational status of the first vehicle. As described above, such a dependency provides the advantage of reducing the likelihood of false warnings that the first vehicle is being followed by increasing the threshold condition for assessing whether the first vehicle is being followed. In this scenario, when the first vehicle is in a certain operational state, a second vehicle may occur in a plurality of captured image frames despite not actively following the first vehicle. For example, if the first vehicle is stationary as a result of traffic, it is likely that the surrounding environment of the vehicle will not change. As a result, a second vehicle is likely to appear in a plurality of image frames as described above, and thus may be identified as following the first vehicle, which may be undesirable in this environment. By allowing the predefined threshold condition to be dependent on the situational status of the first vehicle, this situation may be avoided.

The predefined threshold condition may relate to a minimum number of appearances of the second vehicle in the one or more identified vehicles, and determining if the predefined threshold condition is satisfied comprises determining if the number of appearances of the second vehicle in the one or more identified vehicles is equal to or greater than the minimum number of appearances.

Optionally, the method may comprise receiving information associated with the second vehicle, the information enabling the second vehicle to be identified from the captured image data, and determining if the second vehicle appears more than once within the one or more identified vehicles comprises using the received information to identify the second vehicle. In certain embodiments the information associated with the second vehicle may be received from any one or more of: a remotely located server; roadside infrastructure; and a third vehicle having communication means with the first vehicle. The communication means may relate to any communication device enabling the first and third vehicle to communicate with each other. This provides the advantage of allowing the first vehicle to review additional external sources for information relating to a specific vehicle which is following it, and provides a larger information source than would be available from the vehicle's monitoring equipment alone.

Optionally, the method may further comprise sending information associated with the second vehicle to any one of: a remote server; and a further vehicle, the information enabling the second vehicle to be identified from captured image data of the second vehicle, when it is determined that the second vehicle is following the first vehicle. This offers the advantage of allowing received information regarding a vehicle following the first vehicle to be shared with other users, such as in a fleet or convoy of vehicles.

Optionally, analysing the captured image data to identify the one or more vehicles comprises identifying a vehicle registration identifier associated with a vehicle. This offers a simple means of identification of following vehicles. Additionally, this has the advantage of reducing the processing resources needed to identify a following vehicle when in comparison to a method which requires a plurality of information to identify a following vehicle, where this plurality of information may include for example a vehicle's manufacturer, colour and/or specific model.

A further aspect of the invention relates to a controller for determining if a first vehicle is being followed by a second vehicle. The controller may be arranged to receive captured image data from an image capture device, of one or more vehicles in the vicinity of the first vehicle over a time period. The controller may comprise a processing device configured to: analyse the captured image data to identify one or more vehicles; and determine that the second vehicle is following the first vehicle, in dependence on the second vehicle appearing more than once amongst the one or more identified vehicles. This aspect and its optional features share and provide the same advantages as conveyed by previously described aspects of the invention.

The controller may comprise an output configured to output a notification signal, in dependence on the second vehicle being determined to be following the first vehicle.

Optionally, the output may be configured to output the notification signal to any one of a visual display located within the first vehicle and an audio alert system located within the first vehicle.

In certain embodiments, the controller may be configured to analyse one or more characteristics of the captured image data to identify one or more vehicles.

The controller may be configured to determine if the second vehicle is following the first vehicle by monitoring if a predefined threshold condition is satisfied.

Optionally, the controller may be configured to select the predefined threshold condition in dependence upon an environment in which the first vehicle is travelling. In certain embodiments, the environment may dependent on one or more of: traffic levels; road types; road conditions; average road speed; location of the road; and classification of roads.

The controller may be configured to select the predefined threshold condition in dependence upon a situational status of the first vehicle.

As with a previous aspect of this invention, the predefined threshold condition may relate to a minimum number of appearances of the second vehicle in the one or more identified vehicles. The controller may be configured to determine if the predefined threshold condition is satisfied by determining if the number of appearances of the second vehicle in the one or more identified vehicles is equal to or greater than the minimum number of appearances.

The controller may comprise a receiver configured to receive information associated with the second vehicle, the information enabling the second vehicle to be identified from the captured image data with the controller being configured to determine if the second vehicle appears more than once within the one or more identified vehicles by using the received information to identify the second vehicle. The receiver may be configured to receive the information associated with the second vehicle from any one or more of: a remotely located server in operative communication with the receiver; roadside infrastructure; and a third vehicle in operative communication with the first vehicle.

Optionally, the controller may be configured to output information associated with the second vehicle to a transmitter, the information enabling the second vehicle to be identified from captured image data of the second vehicle.

The controller may be configured to analyse the captured image data to identify the one or more vehicles by identifying a vehicle registration identifier associated with a vehicle.

A further aspect of the invention relates to a system for determining if a first vehicle is being followed by a second vehicle, the system comprising the aforementioned controller and an image capture device. This aspect of the invention shares the same advantages conveyed by the previous aspects described above.

In certain embodiments the system may comprise an interface configured to enable an occupant of the vehicle to interact with the system. This conveys the advantage of allowing a user to adjust various settings of the system in order to achieve a personalised experience.

A further aspect of the invention relates to a not-transitory, computer-readable storage medium storing instructions thereon that when executed by one or more processors causes the one or more processors to carry out the method of the preceding aspects of the invention. This aspect of the invention shares the same advantages conveyed by the previously described aspects.

In certain embodiments the computer program product comprises instructions for: capturing image data from a first vehicle of one or more vehicles in the vicinity of the first vehicle over a time period, analyse the captured image data to identify one or more vehicles, and determining that the second vehicle is following the first vehicle, in dependence on the second vehicle appearing more than once amongst the one or more identified vehicles.

The computer program product may comprise instructions, which when executed on a processor, configure the processor to: receive image data captured from a first vehicle of one or more vehicles in the vicinity of the first vehicle over a time period, analyse the captured image data to identify one or more vehicles, and determine that the second vehicle is following the first vehicle, in dependence on the second vehicle appearing more than once amongst the one or more identified vehicles.

Yet a further aspect of the invention relates to a vehicle comprising the aforementioned controller or the aforementioned system. This aspect of the invention shares the same advantages conveyed by the previously described aspects.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic illustration of a vehicle comprising a system for detecting if the vehicle is being followed, according to an embodiment of the invention;

FIG. 2 is a top-down view of the vehicle of FIG. 1 capturing image data of a plurality of other vehicles in the vehicle's vicinity;

FIG. 3 is a functional diagram highlighting the functional components of the system of FIG. 1, including associated inputs into, and outputs from, the system;

FIG. 4 is a process flow chart outlining the method carried out by the system of FIG. 1, in accordance with an embodiment;

FIG. 5 is a process flow chart providing further detail regarding step 46 of FIG. 4, in accordance with an embodiment;

FIG. 6 is a process flow chart highlighting steps comprised in an alternative embodiment of FIG. 4;

FIG. 7 is a process flow chart highlighting further steps comprised in the process of FIG. 4, in accordance with an embodiment;

FIG. 8 is a process flow chart highlighting further steps comprised in the method of FIG. 4, in accordance with an embodiment;

FIG. 9 is a schematic, side-on view of a vehicle convoy, each vehicle configured with the system of FIG. 1, and illustrates an example of how the system may be used in accordance with an embodiment;

FIG. 10 is a schematic top view of two vehicles configured with the system of FIG. 1, and illustrates a further example of how the system may be used;

FIG. 11 is a schematic top view of a vehicle configured with the system of FIG. 1, interacting with existing road infrastructure, in accordance with a further embodiment of the invention.

### DETAILED DESCRIPTION

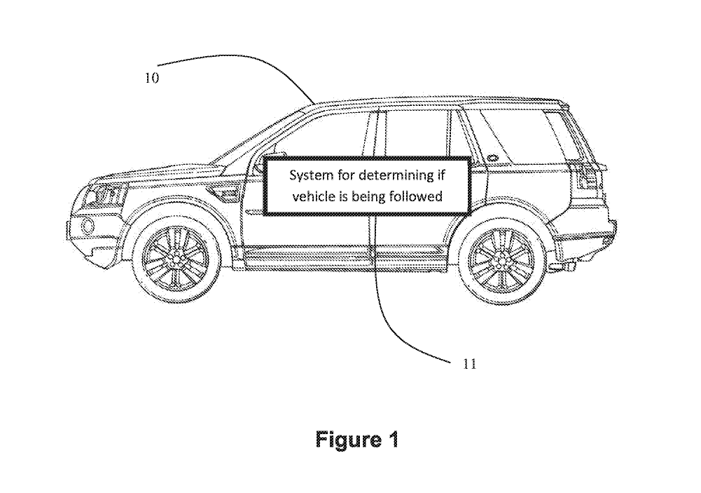

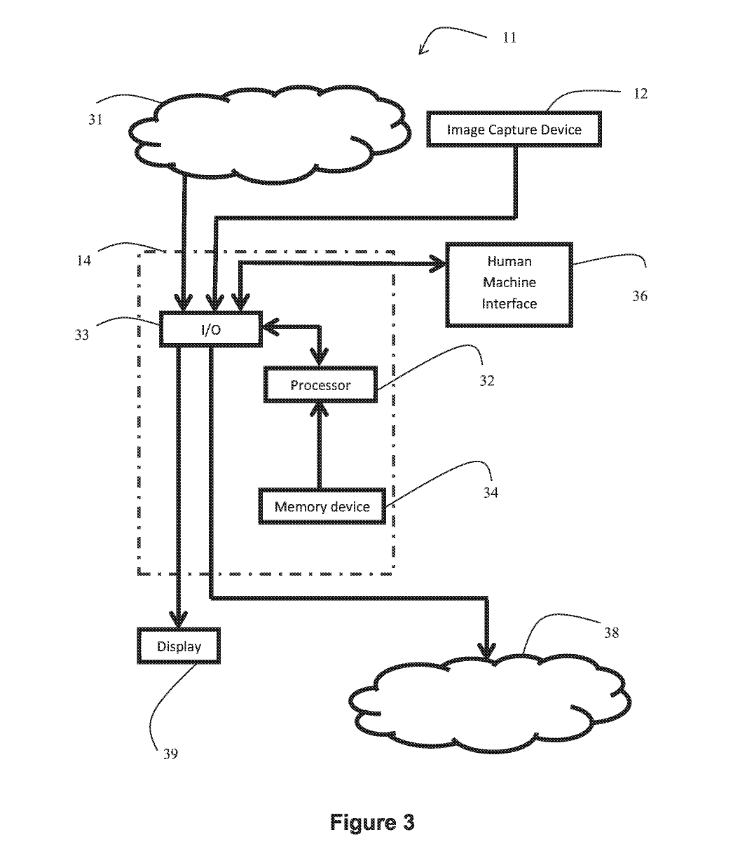

FIG. 1 illustrates a vehicle 10 comprising a system 11 for determining if the vehicle is being followed. The system 11 may comprise an image capture device 12 and an image analysis controller 14 as shown in FIG. 3. The image capture device 12 may comprise any suitable device such as a camera, configured to capture images of the vehicle's 10 surroundings over a period of time. For example, the image capture device may be configured to periodically capture images of neighbouring vehicles. In an alternate embodiment, the system 11 may comprise the image analysis controller 14 only.

The image analysis controller 14 may comprise a processing system which may be located in the vehicle 10, configured to identify objects present in the captured image data. These image objects may relate to neighbouring vehicles in the vicinity of the first vehicle, identified by their shape, colour and size, as determined from the captured image data. Similarly, vehicle registration plates may also be used to identify vehicles within the captured image data. The image analysis controller 14 may be configured to identify the alphanumeric identifiers associated with the vehicle registration plates from the captured image data. The captured image data may be analysed in order to determine whether any recurring vehicles are present in the captured image data. For example, this may comprise determining whether the same vehicle is observed as recurring in a captured sequence of images. This may be achieved by using the image analysis controller 14 to analyse the captured images in order to identify recurring vehicles, on the basis of characteristics unique to each vehicle, derivable from the captured image data.

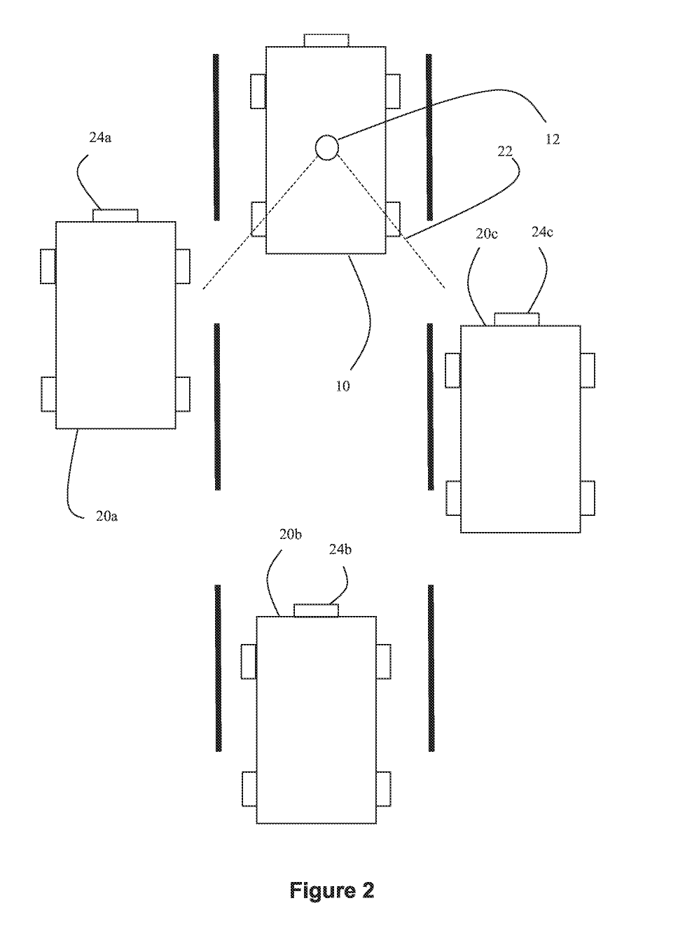

An example of how the system 11 may be used is shown in FIG. 2, where the vehicle 10 is shown in operation driving on a road. In such an embodiment, the system may be configured to notify the driver of the vehicle 10 if one or more vehicles 20a, 20b, 20c is following the vehicle 10. Although the image capture device 12 is shown as being located in a substantially central location on an exterior of the vehicle 10, this is for illustrative purposes only, and the image capture device 12 may be disposed at any suitable location on the vehicle 10, such that it is able to capture image data of the external environment surrounding the vehicle 10.

The image capture device 12 is shown with a triangular field of view 22 which represents the area in which the device 12 is able to capture image data. It is to be appreciated that the illustrated view is not to scale, and is for illustrative purposes only. Accordingly, in certain embodiments it is envisaged that image capture devices having a 360 degree horizontal field of view are used. For present purposes the precise characteristics of the capture device's field of view are immaterial, provided that they enable image data of the vehicle's surroundings to be captured. Accordingly, image capture devices with different fields of view may be used in accordance with different embodiments of the invention.

The image data captured by the image capture device 12 is subsequently input to the image analysis controller 14 located inside the vehicle, which is configured to identify other vehicles 20a, 20b, 20c in the captured image data. In some embodiments vehicles 20a, 20b, 20c may be uniquely identified within the captured image data on the basis of their vehicle registration plates 24a, 24b, 24c. In such embodiment the image analysis controller 14 may be further configured to identify the alphanumeric identifiers associated with the vehicle registration plates 24a, 24b, 24c. Alternatively, characterising details of the vehicles 20a, 20b, 20c such as vehicles shape, size and/or colour may be used to uniquely identify the vehicles 20a, 20b, 20c.

By analysing image data captured over a period of time, the image analysis controller 14 is able to determine if any of the vehicles 20a, 20b, 20c appear recurrently in the captured images, where the recurrence condition may comprise any of the vehicles 20a, 20b, 20c appearing more than once in the captured images. The recurrence condition may also be defined in an alternative manner, which will be described in more detail below. If it is observed that one or more of the vehicles 20a, 20b, 20c is identified as appearing recurrently in the captured images, then the image analysis controller 14 may determine that the vehicle is following the first vehicle 10. The driver of the first vehicle 10 may then be subsequently notified. The driver may then take appropriate action on the basis of this information, for example, by performing manoeuvres to prevent the following vehicle(s) 20a, 20b, 20c from continuing to follow the first vehicle 10.

As mentioned previously, whilst the horizontal field of view 22 illustrated covers an angle of approximately 90 degrees, in alternative embodiments the angle of the horizontal field of view 22 of the image capture device 12 may range in value from greater than 0 degrees to less than or equal to 360 degrees. This may cover regions both in front of and behind the vehicle 10. Similarly, the vertical field of view of the image capture device 12 may range in angle value from greater than 0 degrees to less than or equal to 180 degrees. This may cover regions above and below the vehicle 10. When considering the horizontal field of view 22 in combination with the vertical field of view, the image capture device 12 may be configured to capture image data in a full sphere around the vehicle 10.

FIG. 3 illustrates the functional components comprised in the system 11, comprising an image analysis controller 14 configured to receive image data from an image capture device 12. The functional components of the image analysis controller may include a processor 32, an input/output device 33 configured to receive input from external sources and to transmit output to external sources, and a hardware memory device 34. The hardware memory device 34 may also be located externally to the image analysis controller 14. The I/O device 33 may comprise any one or more of a suitable receiver, transmitter and/or transceiver. FIG. 3 also illustrates inputs to the image analysis controller 14, namely the provision of image data by the image capture device 12, information which may be provided from a source external to the vehicle 31 such as a shared communications network, and a human-machine interface 36 to enable a driver or other vehicle occupant to define the settings for the image analysis controller 14. FIG. 3 further illustrates the outputs from the image analysis controller 14, which may relate to the results of the image analysis being output to a display located in the vehicle 39. In certain embodiments the aforementioned human-machine interface 36 may also be configured to receive outputs from the image analysis controller 14. For example, where the human-machine interface 36 comprises a display, the aforementioned display 39 may be comprised within the human-machine interface 36. In addition, in certain embodiments the results of the analysis may be provided to a remotely located recipient including a remote computing means, for example a remotely located server via a shared communications network 38. This may be achieved using any suitable wireless communications device.

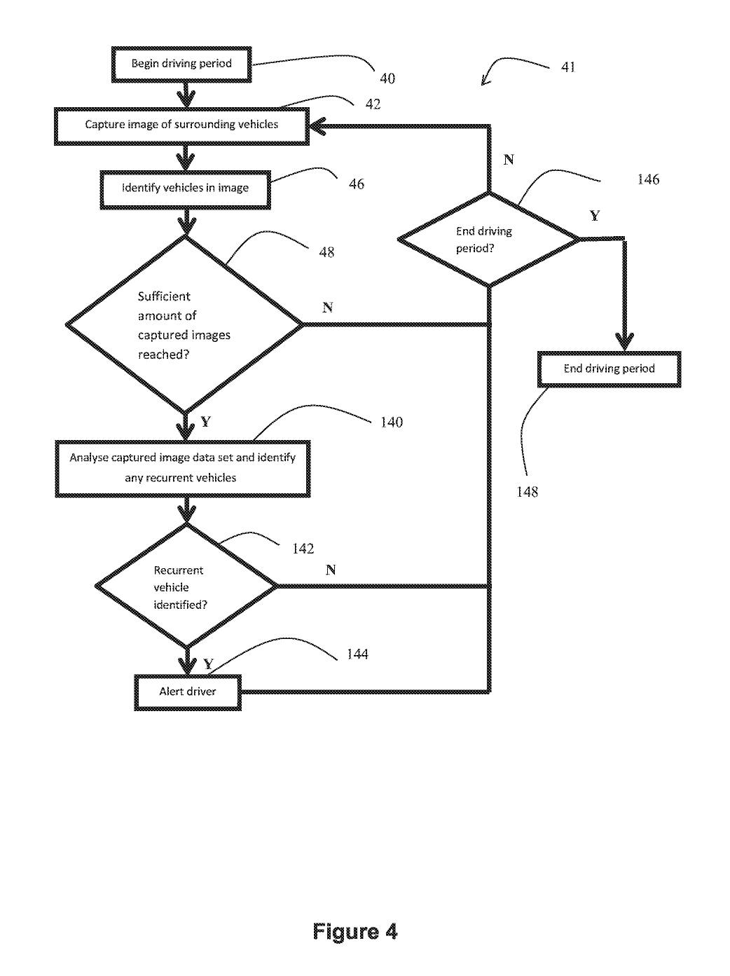

FIG. 4 illustrates the method carried out by the system 11 for determining if the first vehicle is being followed, from captured image data. The method is initiated at step 40 when a driving period begins. The beginning of the driving period may be detected automatically in a plurality of ways, for example, by the engaging of the ignition of the vehicle 10, or once the vehicle 10 has reached a predetermined velocity.

Once the driving period has begun, the image capture device 12 may be configured to repeatedly capture image data 42 of vehicles in the vicinity of the first vehicle 10. The image data may be captured according to a predetermined capture rate. This predetermined capture rate may be specified by persons other than the driver of the vehicle 10. Alternatively, the predetermined capture rate may be specified by the driver of the vehicle 10.

The predetermined capture rate may be varied if desired during a vehicle journey. For example, the driver may decide to vary the image capture rate when moving a motorway for example to a country lane). On a motorway, it may be expected that vehicles 20a, 20b, 20c in the vicinity of the first vehicle 10 remain in the vicinity for a longer period of time than on a country lane, as there are fewer possible alternate routes for the vehicles 20a, 20b, 20c to take. In this circumstance, the driver may wish to lower the frequency of image capture in order to reduce the processing requirements of the system 11. Similarly, the driver may choose to vary the image capture rate when travelling in a city, compared with traveling in a suburban environment. The frequency of capture may be adjusted also whilst the vehicle 10 is stationary between driving periods. The frequency of capture may be varied by the driver of the vehicle 10 using a human-machine interface.

When image data relating to the first vehicle's surrounding environment has been captured 42 using the image capture device 12, the image data may be transmitted to the image analysis controller 14, where the captured image data is analysed to identify surrounding vehicles present within the image data, at step 46. Similarly, the image analysis controller 14 may be configured to batch process multiple images, in which case the system waits until a few images have been received before an analysis is performed.

Each captured image may contain image data associated with a plurality of different vehicles 20a, 20b, 20c. To handle such scenarios, the image analysis controller 14 may be configured to distinguish between different image objects in order to enable it to individually identify each one of the plurality of different vehicles 20a, 20b, 20c in the captured images.

In certain embodiments, rather than storing the entire captured image data of each identified vehicle in the hardware memory device 34, only characteristic data associated with each identified vehicle are stored. Such characteristic data enables each vehicle to be uniquely identified in subsequent captured images. For example, such characteristic data may relate to the vehicle's registration number plate, as mentioned previously. Storing only characteristic data enabling each vehicle to be uniquely identified, rather than the entire captured image data set, reduces the amount of storage required in the hardware memory device 34.

At step 48, it is determined whether a sufficient number of images have been captured to enable an analysis of the following vehicles to be carried out for the purposes of determining if the first vehicle 10 is being followed. Determining whether a sufficient number of images have been captured may comprise determining whether a predetermined threshold condition has been satisfied.

Different criteria may be used to define the predetermined threshold condition. For example, it may be defined in terms of a minimum number of captured images. Alternatively, the threshold condition may be defined in terms of a minimum time period over which image data has been captured. The threshold condition may be specified by the driver of the first vehicle 10, any other user of the vehicle, or by the vehicle manufacturer. The threshold condition may also be dependent on the travel environment of the vehicle 10, which may be dependent on road traffic levels, road types, road conditions, average road speed, location of the road and classification of a road.

Once it is determined that a sufficient number of captured images have been captured, the image analysis controller 14 proceeds to analyse the captured image data stored in the hardware memory device 34, at step 140, in order to identify any recurrently appearing vehicle in the captured image data.

If instead it is determined at step 48 that an insufficient number of captured images have been captured, then the image analysis controller 14 may be configured to cease any further analysis of the captured image data, until a sufficient amount of images have been captured by the image capture device 12, and steps 42, 46 and 48 are repeated, until it is determined at step 48 that a sufficient number of images have been captured, or until the driving period is determined to have ended, as shown at step 146. In this case, the method is terminated at step 148.

Once it is determined that a sufficient number of captured images have been captured at step 48, then the image analysis controller 14 may be arranged to analyse the captured image data in order to determine if any vehicles appear recurrently in the captured images at step 140. In certain embodiments, determining if a vehicle appears recurrently within the captured image data may comprise use of a predetermined threshold condition. For example, such a threshold condition may relate to a minimum number of occurrences of a vehicle in the captured images in a period of time. Similarly, the threshold condition may be defined as a percentage, in which in order to satisfy the condition a vehicle would need to be identified as appearing recurrently in a minimum percentage of the total number of images captured over a given time period, for example, in approximately at least 50%, 55%, 60%, 65%, 70% 75%, 80%, 85%, 90% or 95% of the total number of captured images. In a further example, the number of occurrences of a vehicle in the captured images in a period of time may exceed the average number of occurrences of a vehicle, for example, 10%, 20%, 30%, 40%, 50% or greater of the total number of vehicle occurrences. The average number of occurrences of a vehicle may be the mean number of time a vehicle is identified.

As with the predetermined capture rate described above, the threshold condition may be adjustable. This may allow the threshold condition to be adapted to the environment of the vehicle. For example, in instances where vehicles 20a, 20b, 20c in the vicinity of the first vehicle 10 are more likely to remain in the vicinity of the vehicle given the context in which the vehicle is being operated, the driver may wish to specify that the threshold condition for identifying a vehicle as recurrent is stricter than in environments where such vehicles 20a, 20b, 20c are less likely to remain in the vicinity of the first vehicle 10.

At step 142 it is determined if the threshold condition for identifying a vehicle as appearing recurrently within the captured image data has been satisfied. If it is determined that a vehicle appears recurrently within the captured image data, then the details of the vehicle may be presented to the driver of the first vehicle 10, at step 144. The details of the recurrent vehicle may be presented on an output display screen 39 of the vehicle 10. Similarly, details of the recurrent vehicle may be provided through an audio notification, either in addition to, or instead of, the information being displayed on an output display screen 39.

Following the alert to the driver, the system may be configured to repeat steps 42 through 146 in order to continue identifying recurrent vehicles in the captured image data. This process may be continued until the driving period is determined to have ended, at step 146. The method is then terminated at step 148.

If instead it is determined at step 142 that the threshold for identifying a vehicle as being recurrent has not been satisfied, then steps 42 through 142 are repeated, until a recurrently appearing vehicle has been identified at step 142, or until the driving period is determined to have ended, at step 146. The method is then terminated at step 148.

In further embodiments it is envisaged that the first vehicle 10 may automatically adjust the threshold condition for identifying a vehicle as being recurrent, based on a situational status of the first vehicle 10, for example when detecting that the first vehicle 10 is stationary in traffic. In such a scenario it is expected that captured image data will comprise many recurrently appearing vehicles, especially if the traffic is stationary, since the vehicles 20a, 20b, 20c in the vicinity of the first vehicle are unlikely to change for a relatively long period of time. This may help to reduce the number of false alerts issued to the driver in situations where a high amount of recurrent vehicles are to be expected, and are not necessarily indicative of the first vehicle 10 being followed. This may be achieved by using sensors disposed within the vehicle 10 configured to assess the position, velocity and engine status of the vehicle, and in response to sensor measurements adjust the threshold condition for determining if a vehicle appears recurrently in the captured image data.

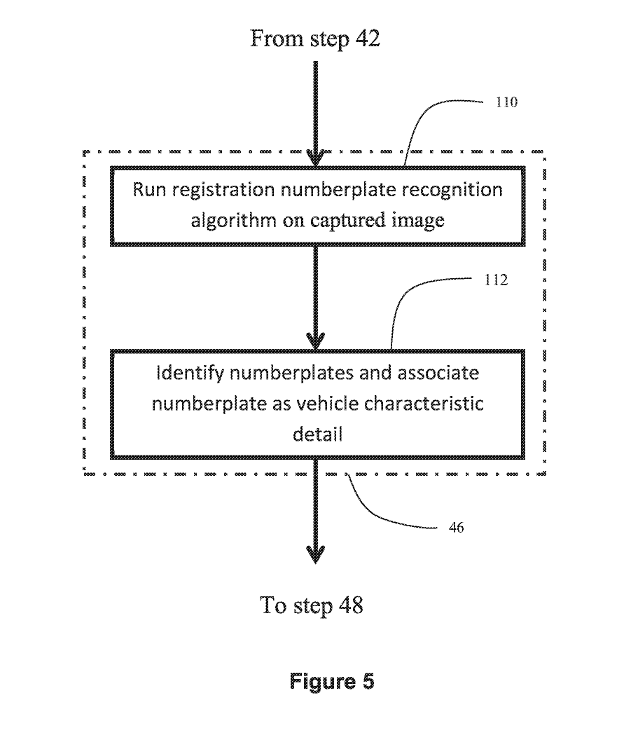

FIG. 5 shows a further embodiment of the method of FIG. 4 where vehicles 20a, 20b, 20c are identified by their alphanumeric registration numbers. In this embodiment, following an image being captured in step 42, a registration number plate recognition algorithm may be run on the captured image, at step 110. For example, an Automatic Number Plate Recognition algorithm may be used. In step 112, any number plates detected in the captured image data may be used to uniquely identify the vehicles 20a, 20b, 20 present in the captured image data. This information may subsequently be used, at step 48, to determine if the same vehicle appears recurrently in the captured image data.

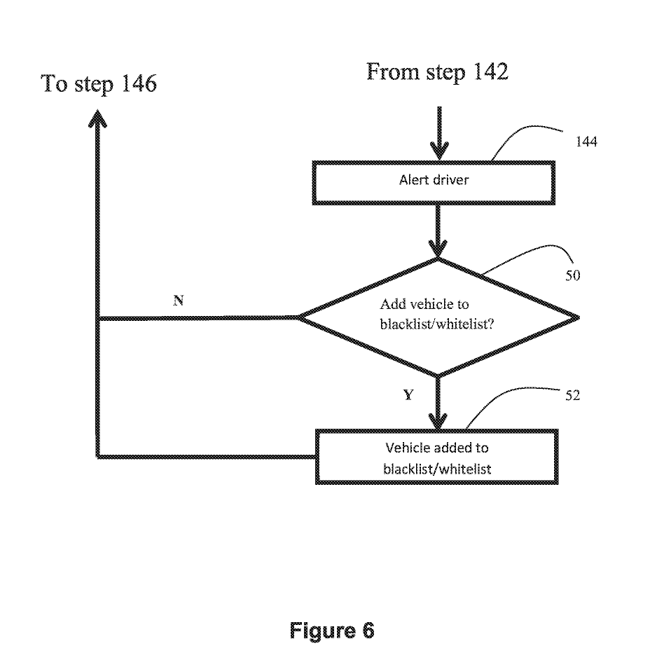

FIG. 6 shows an alternate embodiment of the method of FIG. 4 configured to allow a driver of the vehicle 10 to selectively filter the results of the analysis produced in step 142.

If a recurrent vehicle is identified in step 142, the driver may be alerted, at step 144. At step 50 a further option may be presented to the driver, providing the driver with the option to either add the vehicle to an electronic ‘white’ or ‘black’ list which the system 11 is configured to read. Within the present context, a white list may refer to a list of vehicles which have been identified as non-threatening and authorised to follow the first vehicle 10. When whitelisted vehicles are subsequently identified as recurrent, details of the vehicle need not be presented to the driver. In contrast, within the present context, a black list refers to a list of vehicles specifically identified as not authorised to be following the first vehicle 10. Details of blacklisted vehicles subsequently identified as recurrent, may be presented to the driver. Where vehicles are added to a white list, they will no longer be presented to the driver at step 144 in further iterations of the method. In an embodiment which uses a black list, only vehicles which are added to the black list will be presented to the driver at step 144 in further iterations of the method. The use of white lists and black lists may reduce the amount of unwanted alerts being issued. If a driver determines that they wish to add recurrent vehicles to either list, they may select this option at step 52, using the human machine interface 36. Following this, the system 11 may be configured to continue the procedural steps of FIG. 4 at step 146.

Alternatively, if the driver determines at step 50 that the recurrent vehicles are not to be added to either such list, the system may be configured to continue the procedural steps of FIG. 4 at step 146 without proceeding to step 52.

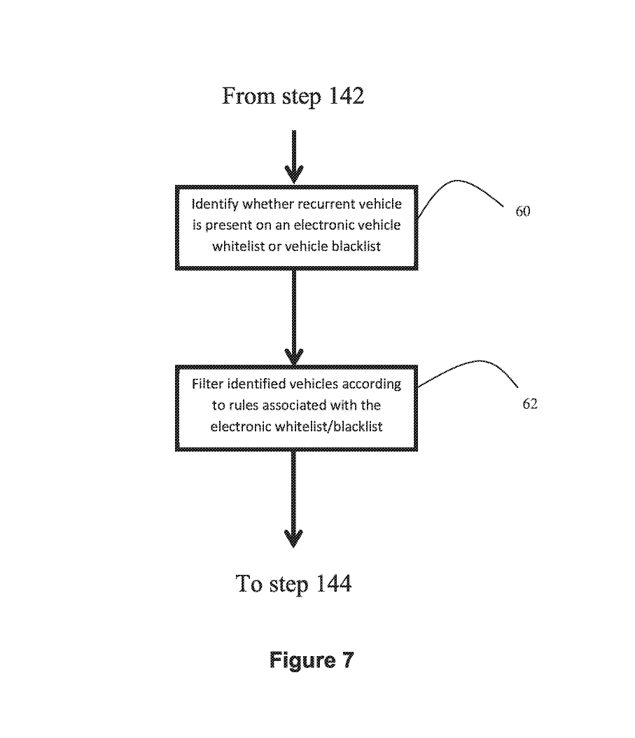

An example of the white list and/or black list data being included in the procedural steps of FIG. 4 is shown in FIG. 7. If, at step 142, recurrent vehicles are identified, the vehicles may be compared to vehicles included on the white list and/or black list, at step 60, to determine if they have been identified on such a list. At step 62, the recurrent vehicles will be selectively filtered according to the rules associated with the white list and/or black lists. The system 11 may then be configured to continue the procedural steps of FIG. 4 at step 144, alerting the driver only of the vehicles which have passed through the filter at step 62.

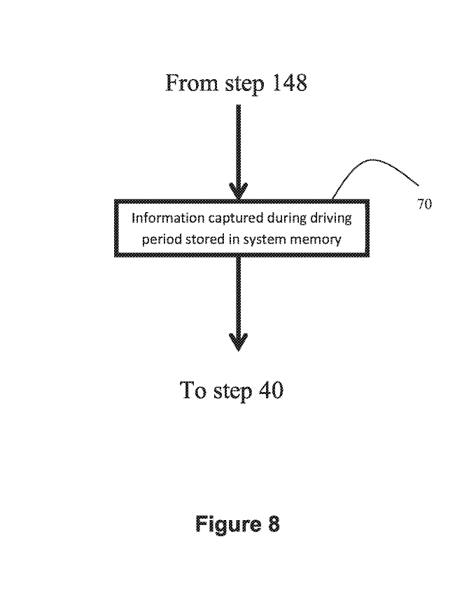

FIG. 8 provides further steps in the method of FIG. 4, in accordance with an embodiment wherein the system 11 is further configured to retain image data captured during a first driving period of the vehicle 10 such that it may be accessed in subsequent driving periods by the vehicle 10. The system 11 may also be configured to retain information relating to vehicles which have been added to an electronic white list or electronic black list, as described above, such that it may be accessed in subsequent driving periods.

In this embodiment, when a driving period is determined to be ended 144 as described above, the image analysis controller 14 is configured to store information received during the driving period in a hardware memory device 34 of the system 70. When a subsequent driving period is determined to have begun 40 as described above, the image analysis controller 14 is also configured to access information stored at the end of previous driving periods.

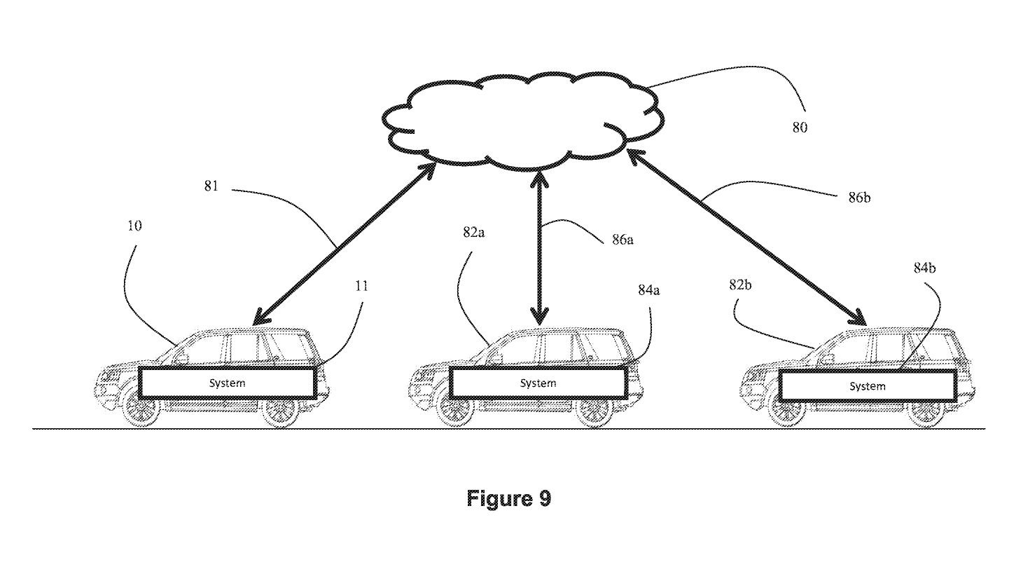

In an embodiment, the system 11 may be configured to exchange information 81 with a remotely located server, device or information store 80, as shown in FIG. 9. This exchange 81 may be configured to occur between driving periods or during a driving period. In an embodiment, this information may comprise image data as described above, configured to be readable by the system 11. In a further embodiment, the information to be exchanged may relate to vehicles which have been added to an electronic white list or black list as described previously.

In yet a further embodiment, the central information store 80 may be further configured to exchange information 86a, 86b with a plurality of other vehicles 82a, 82b, each of which may comprise a system to determine if the vehicle is being followed 84a, 84b. This is particularly useful when traveling in a vehicle convoy or fleet, and may enable the first vehicle 10 to indirectly provide other fleet vehicles 84a, 84b with information about following vehicles.

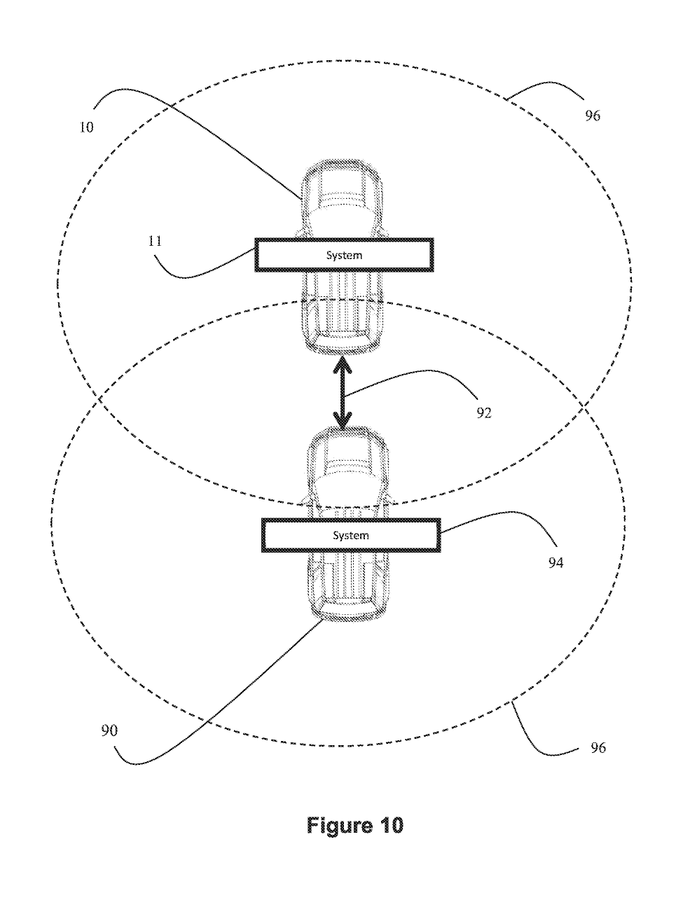

FIG. 10 shows an embodiment of the system 11 of FIG. 1, where the system 11 of the first vehicle 10 may be further configured to exchange information 92 directly with a second vehicle 90 with a second system 94. For example, this may be achieved by a suitable wireless communication channel. In a further embodiment, the system 11 of the first vehicle 10 may be configured to exchange information 92 only when the two systems 11, 94 are within a predetermined distance 96 from the device, for example, 10 metres.

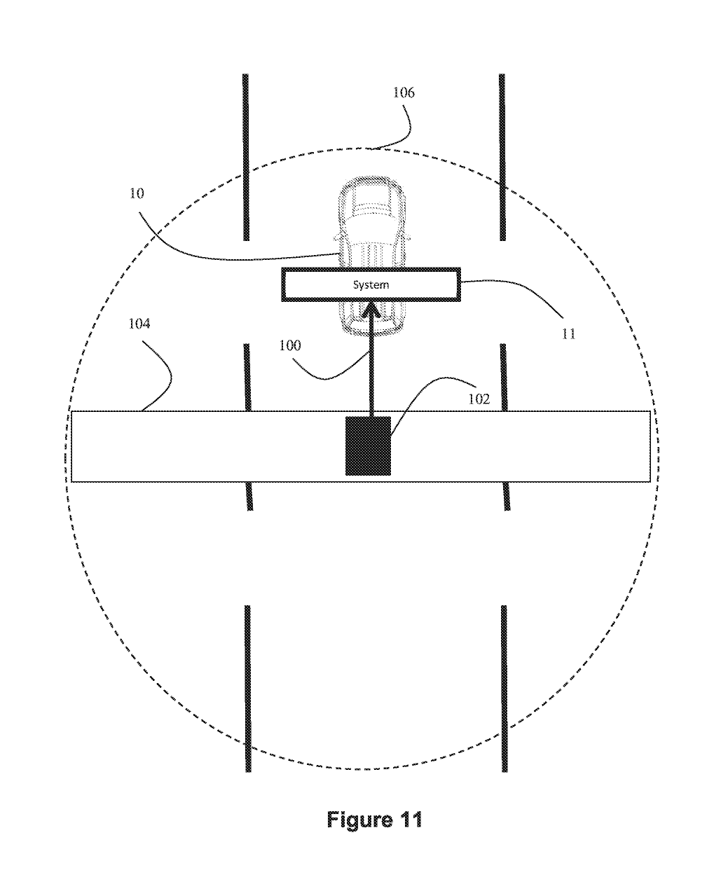

FIG. 11 shows a further embodiment of the system 11 of FIG. 1, where the system 11 of the vehicle 10 may be further configured to receive image data 100 from existing road infrastructure, such as Automatic Number Plate Recognition cameras 102 installed on overhead gantries 104 on motorways. ANPR cameras 102 such as these may offer a greater field of view of vehicles surrounding the first vehicle 10 than may be provided by the image capture device 12 installed on the vehicle 10 and therefore are able to provide more information to be analysed by the system 11. Transfer of information 100 may be achieved by suitable wireless communications. In a further embodiment, the system 11 of the vehicle 10 may be configured to receive image data from roadside infrastructure only when they are within a predetermined distance from the device 106, for example, 100 metres.

Many modifications may be made to the above examples without departing from the scope of the present invention as defined in the accompanying claims.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification, and/or all of the steps of any method or process so disclosed, may be combined in any combination, except combinations where at least some of such features and/or steps are mutually exclusive.

Each feature disclosed in this specification, may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification, or to any novel one, or any novel combination, of the steps of any method or process so disclosed. The claims should not be construed to cover merely the foregoing embodiments, but also any embodiments which fall within the scope of the claims.

1. A method of determining if a first vehicle is being followed by a second vehicle, the method comprising:
capturing image data from the first vehicle, of one or more vehicles in the vicinity of the first vehicle, over a time period;
analysing the captured image data to identify one or more vehicles; and
determining that the second vehicle is following the first vehicle, in dependence on the second vehicle appearing more than once among the one or more identified vehicles.

2. The method of claim 1, wherein the method comprises:
alerting an occupant of the first vehicle when the second vehicle is determined to be following the first vehicle and
analysing one or more characteristics of the captured image data to identify the one or more vehicles.

3. The method of claim 2, wherein the captured image data comprises a plurality of image frames, the analysing comprises identifying one or more vehicles within the plurality of image frames, and the determining comprises establishing if the same vehicle appears in two or more of the image frames, captured over the time period.

4. The method of claim 1, wherein determining if the second vehicle is following the first vehicle comprises:
determining if a predefined threshold condition is satisfied.

5. The method of claim 4, wherein the predefined threshold condition is dependent on an environment in which the first vehicle is traveling.

6. The method of claim 5, wherein the environment is dependent on one or more of: traffic levels; road types; road conditions; average road speed; location of the road; and classification of roads.

7. The method of claim 4, wherein the predefined threshold condition is dependent on a situational status of the first vehicle.

8. The method of claim 4, wherein the predefined threshold condition is a minimum number of appearances of the second vehicle in the one or more identified vehicles, and determining if the predefined threshold condition is satisfied comprises determining if the number of appearances of the second vehicle among the one or more identified vehicles is equal to or greater than the minimum number of appearances.

9. The method of claim 1, comprising:
receiving information associated with the second vehicle, the information enabling the second vehicle to be identified from the captured image data;
determining if the second vehicle appears more than once among the one or more identified vehicles using the received information to identify the second vehicle; and
when it is determined that the second vehicle is following the first vehicle, sending information associated with the second vehicle to any of a remote server and a further vehicle, the information enabling the second vehicle to be identified from captured image data of the second vehicle,
and wherein the information associated with the second vehicle is received from any of:
a remotely located server;
roadside infrastructure; and
a third vehicle in communication with the first vehicle.

10. The method of claim 1, wherein analysing the captured image data to identify the one or more vehicles comprises identifying a vehicle registration identifier associated with a vehicle.

11. A controller for determining if a first vehicle is being followed by a second vehicle, the controller being arranged to receive captured image data from an image capture device, of one or more vehicles in a vicinity of the first vehicle over a time period, and the controller comprising a processing device configured to:
analyse the captured image data to identify one or more vehicles; and
determine that the second vehicle is following the first vehicle, in dependence on the second vehicle appearing more than once among the one or more identified vehicles.

12. The controller of claim 11, comprising:
an output configured to output a notification signal, in dependence on the second vehicle being determined to be following the first vehicle and wherein the output is configured to output the notification signal to any of:
a visual display located within the first vehicle; and
an audio alert system located within the first vehicle.

13. The controller of claim 11, wherein the controller is configured to analyse one or more characteristics of the captured image data to identify the one or more vehicles.

14. The controller of claim 11, wherein the controller is configured to determine if the second vehicle is following the first vehicle by monitoring if a predefined threshold condition is satisfied.

15. The controller of claim 14, wherein the controller is configured to select the predefined threshold condition in dependence upon an environment in which the first vehicle is travelling and wherein the environment is dependent on any of: traffic levels; road types; road conditions; average road speed; location of the road; and classification of roads.

16. The controller of claim 14, wherein the controller is configured to select the predefined threshold condition in dependence upon a situational status of the first vehicle.

17. The controller of claim 14, wherein the predefined threshold condition is a minimum number of appearances of the second vehicle among the one or more identified vehicles, and the controller is configured to determine if the predefined threshold condition is satisfied by determining if the number of appearances of the second vehicle among the one or more identified vehicles is equal to or greater than the minimum number of appearances.

18. The controller of claim 14, comprising:
a receiver configured to receive information associated with the second vehicle, the information enabling the second vehicle to be identified from the captured image data; and
the controller being configured to determine if the second vehicle appears more than once among the one or more identified vehicles by using the received information to identify the second vehicle and wherein the receiver is configured to receive the information associated with the second vehicle from any of:
a) a remotely located server in operative communication with the receiver;
b) roadside infrastructure; and
c) a third vehicle in operative communication with the first vehicle.

19. A system for determining if a first vehicle is being followed by a second vehicle, the system comprising: the controller of claim 11, an image capture device and an interface configured to enable an occupant of the vehicle to interact with the system.

20. A non-transitory, computer-readable storage medium storing instructions thereon that when executed by one or more processors causes the one or more processors to carry out the method of claim 1.
